(19) United States
(12) Patent Application Publication
(10) Pub. No.: US 2005/0021408 A1
(43) Pub. Date: Jan. 27, 2005

(54) Method and apparatus for retail sales of articles

(76) Inventors: Jonathan D. Sieber, Wayland, MA (US); Joseph S. Sieber, Weston, MA (US)

Correspondence Address: Jamie H. Rose;Wolf, Greenfield & Sacks, P.C., 600 Atlantic Avenue, Boston, MA, 02210, US

(21) Appl. No.: 10/846,138

(22) Filed: May 14, 2004

Related U.S. Application Data
(60) Provisional application No. 60/471,388, filed on May 16, 2003.

(51) Int. Cl. G06F 17/60

(52) U.S. Cl. 705/16; 705/27

(57) ABSTRACT

A method and apparatus for merchandising articles at a retail shop feature displaying to retail customers one or more articles, offering for sale a customer-selectable number of the articles, receiving from a retail customer a request to purchase two or more of the articles, and fabricating at least one article at the retail shop to provide to the retail customer the exact number of requested articles.

### RELATED APPLICATIONS

This application claims priority under 35 U.S.C. § 119(e) to U.S. Provisional Application Ser. No. 60/471,388 entitled “Method And Apparatus For Providing And/Or Distributing Social Stationary,” filed on May 16, 2003, which is herein incorporated by reference in its entirety.

### BACKGROUND OF INVENTION

1. Field of Invention

The invention relates to retail inventory control, and, more particularly, to methods and apparatus for retail sales of articles in customer selectable amounts.

2. Discussion of Related Art

Retail customers often desire displays of items offered for sale. Such items include, for example, articles of social stationery, such as greeting cards, get-well cards, birthday or anniversary cards, thank-you notes, invitations (including enclosures, such as RSVP cards), dinner seating place cards, napkins, envelopes, decorations such as banners, stationery, etc. Retailers often provide social stationery to consumers in one of two forms: as pre-printed social stationery—commonly available at retail stores such as card shops or party supply retailers; or by an on-demand production facility through which the consumer can select from various colors, patterns, themes, or images, arrange these elements according to their desire, and then have their desired arrangement printed on-demand.

In the first of these two forms, the retailer must often stock a great variety of pre-printed social stationery to provide a wide selection that accommodates the individual tastes of potential customers. Maintenance of a large inventory, however, can be expensive for the retailer. Advantageously, however, large purchases can provide the retailer with an economy of scale; a retail may be able to purchase pre-printed social stationery in bulk from at a relatively low cost per article. Moreover, preprinted articles permit a consumer to purchase a quantity of the articles with little or no delay. A retailer generally seeks to limit inventory of preprinted items because overstocking can produce unsold items that must be, for example, thrown out, returned to a distributor, stored for later sale, or sold at a discount. Conversely, a retailer may lose potential sales if an item is understocked.

In the second of the two forms, the social stationery can be individually customized by the consumer, but the consumer must spend some time designing the desired article of social stationery, and then wait for their desired order to be produced. A retailer can obtain an on-demand production facility to produce customized items for a customer. An facility to support on-demand production (e.g., a computer-based, social stationery design system, printer, and perhaps finishing station), can, however, lead to a higher cost per finished article of social stationery than for a bulk purchased pre-printed article. Further, the time involved in waiting for the finished articles of social stationery may not be warranted, especially for larger orders.

### SUMMARY OF INVENTION

The invention arises in part from the realization that inventory control can be improved by offering for retail sale articles that are provided through a combination of articles on display and articles fabricated at the retail establishment in response to a retail customer request for a particular number of the articles. A retail establishment can thus improve inventory control by balancing numbers of completed articles offered on display with articles that can be completed by fabrication at the retail establishment. A customer can thus be presented with a display of items ready for sale, but also offered the option to select and receive exactly the number of desired articles of a chosen type. A merchandizing approach, according to principles of the invention, can be applied not only to articles of social stationery but also to a variety of other articles.

Thus, methods and apparatus for providing articles at retail, according to principles of the invention, can provide the combined advantages of both of the above-mentioned forms of providing articles, while overcoming drawbacks of each form. Features of the invention can permit a retailer to provide an inventory of, for example, social stationery from which articles of social stationery may be selected by a consumer, while also permitting one or more matching articles of social stationery to be produced, on-demand. These additional articles of social stationery may be provided because, for example, the retailer's inventory is insufficient to accommodate the consumer's needs, or the consumer only needs a small number of articles of social stationery. For example, a consumer may only need a few articles of social stationery in total, or need only a few additional articles of social stationery in addition to articles of social stationery that are supplied in one or more bulk packages.

Some embodiments, according to principles of the invention, feature certain first types of social stationery that are stocked by the retailer, while other types of social stationery, which coordinate with those first types of social stationery, are produced on-demand. For example, invitations can be stocked for purchase by the retailer, while napkins or seating place cards are provided on-demand.

Accordingly, in one aspect, the invention features a method for merchandising articles at a retail shop. The method includes displaying to retail customers one or more articles, offering for sale a customer-selectable number of the articles, receiving from a retail customer a request to purchase two or more of the articles, and fabricating at least one article at the retail shop to provide to the retail customer the exact number of requested articles. Articles can be fabricated at the retail shop through use of, for example, a printing process.

One or more types of articles can be displayed, and the displayed articles are ready for immediate delivery to a retail customer. Individual or packaged articles can be displayed. Packaged articles can provide one or more articles per package. The customer can select and receive exactly the desired number of articles though the display may not offer a combination of individual articles and/or packaged articles to accommodate the exact number.

### BRIEF DESCRIPTION OF DRAWINGS

The accompanying drawings, are not intended to be drawn to scale. In the drawings, each identical or nearly identical component that is illustrated in various figures is represented by a like numeral. For purposes of clarity, not every component may be labeled in every drawing. In the drawings:

FIG. 1 is a flowchart of an embodiment of a method for merchandizing articles in a retail shop, according to principles of the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

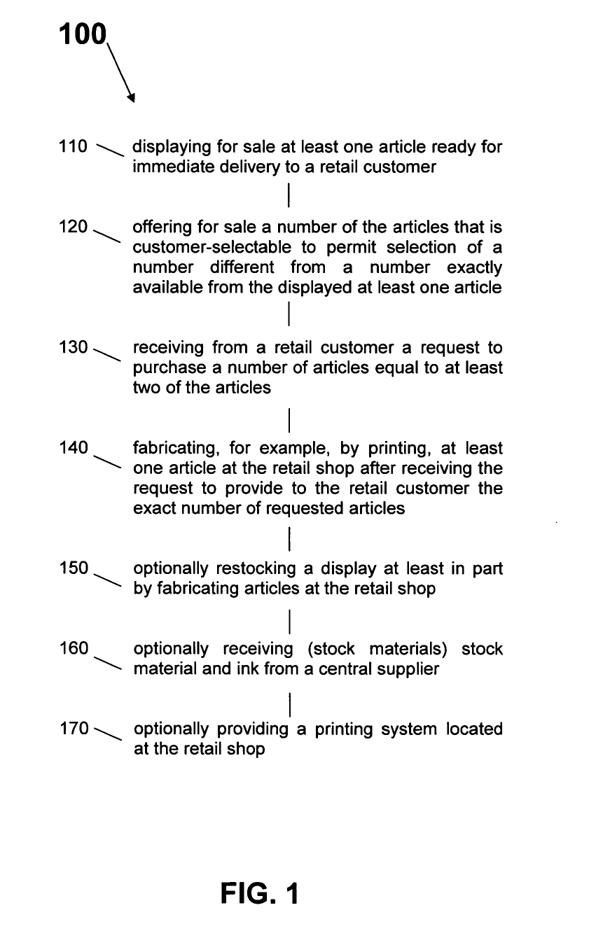

FIG. 1 is a flowchart of a method 100 for merchandising articles in a retail shop, according to principles of the invention. The method includes displaying (Step 110) for sale at least one article that is ready for immediate delivery to a retail customer, offering (Step 120) for sale a number of the articles that is customer-selectable to permit selection of a number different from a number exactly available from the displayed articles, receiving (Step 130) from a retail customer a request to purchase at least two of the articles, and fabricating (Step 140) some of the requested number of articles at the retail shop after receiving the request. For example, at least one article is fabricated at the shop. The customer is thus provided with the exact number of requested articles, though the exact number may not be directly available from a display.

The method 100 can be applied to one or more types of articles, which can be displayed together and/or separately. For the example of invitations, different types of articles can include different types of invitations, and the different types of invitation can be presented on, for example, one or more display racks.

In some embodiments, according to the invention, an article includes a component and a material printed on the component. For example, the article can include a stock component material, such as card-stock or a mug, and have an ink material printed on the card-stock or mug to form lettering and/or a design. Fabricating (Step 140) can thus entail printing a material onto a component. In some embodiments, according to principles of the invention, only printing need be performed at the retail shop to complete the fabrication of articles.

A display (Step 110) can include packaged and/or unpackaged articles. A packaged article includes one or more articles and a container that holds the one or more articles. A container, can be, for example, a box, a ribbon, or envelope. A container can completely or partially enclose one or more articles.

A display (Step 110) can permit a retail customer to immediately take from the display an exact number of articles as constrained by the various available combinations of packaged and/or unpackaged articles on display. For example, if a particular article is displayed in packages of ten articles each, a customer can take from the display a number of the articles equal to a multiple of ten articles, limited by the number of packages on display.

In this example, according to principles of the invention, the customer could request for purchase a number of articles different than a multiple of ten. A retail shop operator can then provide to the customer the exact requested number of articles by fabricating (Step 140) at least some number of the articles. For example, from one to nine articles could be fabricated (Step 140), and a remainder, if any, of the requested exact number could be provided from the display.

Fabricated articles, according to principles of the invention, may be delivered to a customer prior to the customer's departure from the retail shop. An article fabrication system located at the retail shop, including, for example, an inkjet printer, may support quick fabrication of articles. Thus, some embodiments of the method 100, according to principles of the invention, permit a customer to obtain an exact number of desired articles during a relatively brief visit to a retail shop.

Alternatively, a customer may leave the shop while articles are fabricated (Step 140). For example, a customer may browse and/or shop in neighboring stores, latter returning or receiving delivery of articles produced by fabrication at the shop. For example, a customer can to a shop in about an hour, depending on the article and fabrication method, to collect the selected number of articles.

A variety of articles are amenable to retail merchandizing via the method 100. Some amendable types of articles can be qualitatively characterized as being either two-dimensional (“2-D”), two-and-a-half-dimensional (“2½-D”), and/or three-dimensional (“3-D”). For example, 2-D articles include those having features on a nominally flat surface. Such articles include some articles of social stationery, such as invitations, holiday cards, and thank-you notes. These articles can be fabricated (Step 140) by, for example, printing on stock material at the retail shop. The stock material can be blank or have, for example, some preprinted features. The stock material can be, for example, sheets of paper, card-stock, rolls of wallpaper, and poster-stock.

Next, 2½-D articles include, for example, those articles having features on a non-flat surface, for example, a curved surface. Some or all of the features can be introduced by fabrication at a retail shop by, for example, printing on the non-flat surface. Such articles include shaped items, such as mugs, plates, cups, statuettes, trophies, bicycles, and any of a great variety of other items. These articles can be fabricated (Step 140) by, for example, printing on stock material. Stock material can include, for example, paper cups, paper plates, ceramic mugs, etc.

Next, 3-D articles include, for example, those that have substantial three-dimensional features that are fabricated (Step 140) at the retail shop. Fabrication (Step 140) can entail, for example, molding or other forming steps capable of forming three-dimensional objects. Articles of the 3-D type include, for example, medallions and statuettes.

The method 100 can further include restocking (Step 150) a display at least in part by fabricating articles at the retail shop. For example, as needed, articles can be fabricated at the retail shop for the purpose of restocking a display. A number of articles for restocking can be selected in response to a sales history of the articles.

Moreover, displayed articles can be restocked, in part or in whole, by receiving completed packaged and/or unpackaged articles from a centralized source such as a supplier of articles. Thus, a retail shop operator can quickly tailor a number of displayed articles to customer demand and improve inventory control of items ready for sale and stock material ready for use in fabrication. Customer sales can thus be increased while reducing costs arising from overstocked articles.

The method 100 can further include receiving (Step 160) stock materials from a central supplier. The method 100 can also include providing (Step 170) a printing system located at the retail shop. The printing system can support fabrication (Step 140) of completed articles.

In some embodiments, the method 100 is applied to retail sales of articles of social stationery. Social stationery, through use of computer, printing, and finishing technology, can be provided to retail customers in a manner that makes the source of the completed articles essentially indistinguishable to the customer. That is, except for the volume in which social stationery is produced by a centralized manufacturer, an article of social stationery may be produced on-demand in a retail establishment using the same or sufficiently similar computer systems, paper or other media, printing, and finishing technology as used by the manufacturer. Hence, the articles of social stationery produced on-demand by the retail establishment can be indistinguishable from that produced by the manufacturer.

Much equipment used by a typical manufacturer (i.e., the computer systems, the paper or other media, and the printing and finishing technology) is also available at a relatively low cost to a retailer. For example, INSCRIBE, Inc. of Woburn, Mass. offers to retailers an on-demand social stationery production system that allows retail establishments to offer to consumers a way in which to obtain their own customized social stationery. This on-demand social stationery production system may be configured, according to principles of the invention, to provide, on-demand, an article of social stationery that is indistinguishable to that obtained by the retailer in bulk.

Thus, according to principles of the invention, a retailer can stock certain items for display to, and purchase by, a consumer. The consumer can simply “grab and go,” but can obtain additional copies of the same article and/or, for example, other types of articles that coordinate with that article. Should the retailer have an insufficient inventory of the particular article of, for example, social stationery, or should the consumer require a different number of articles of social stationery than that which are provided in bulk, a number of additional copies can provided, on-demand, to the consumer.

As described above, it will be appreciated that this ability to provide a desired number of articles of social stationery, on-demand, to the consumer provides a number of benefits, both to the retailer and to the consumer. First, a retailer can be less concerned with inventory levels, as the likelihood of running out of a particular item is reduced. Should the supply of a particular article of social stationery be low, and a consumer desire more than the retailer has in inventory, the additional amount can be readily produced, often while the consumer waits. The retailer can reduce the frustration of the consumer, who may otherwise need to either select a different article of social stationery for which the supply is sufficient, or may need to travel to another establishment.

Moreover, the ability to provide a desired number of additional articles of social stationery, on-demand to the consumer benefits consumers as well. For example, in the above situation where the retailer does not have a sufficient inventory, the consumer need not travel to another establishment to find the desired article, and need not settle for something that is “second best.” Because the design of the particular article of social stationery may be stored for easy access in the retailer's on-demand production facility, time consuming design steps normally associated with conventional on-demand production facilities may be avoided. For example, those items that are stocked in inventory by the retailer may have a bar code or other type of identifier that can be easily input (manually or by scanning, for example) to the on-demand production facility to quickly select the desired design.

The consumer may also benefit in other ways. For example, the consumer may have the need for, for example, twenty five party invitations, but learn that the invitations are sold only in bulk as a box of twenty invitations per box. Rather than purchasing two boxes of twenty invitations per box, and obtaining fifteen unneeded invitations, the consumer may purchase a single box, and have the remaining five invitations printed on-demand at the retail establishment. Financial and natural resources are thus saved.

Further, according to another aspect of the invention, the retailer may stock only certain articles of social stationery, but be able to accommodate the demand for other articles of social stationery, that may be sold, but are not required to be sold, together. For example, the retailer may decide to stock a number of different types of dinner invitations, but be able to provide, on-demand, dinner seating place cards and napkins that match the dinner invitations. Alternatively, or additionally, for example, RSVP cards that match or otherwise coordinate with the dinner invitations may be provided on-demand. Rather than carrying all of these items in inventory, the retailer may choose to stock only certain types of articles of social stationery, but be able to supply, on-demand matching or coordinated articles of social stationery. This ability reduces inventory costs to the retailer, while providing the consumer with a nearly unlimited choice.

It will be appreciated that because a certain article of social stationery may be stocked by the retailer and stored for easy access in the retailer's on-demand production facility, coordinated articles of social stationery may be readily called up for production. For example, by inputting to the on-demand production facility an identifier of a particular dinner invitation, a listing or display of coordinated types of articles of social stationery, such as RSVP cards, napkins, seating place cards, etc. may be called up for viewing and/or production for the consumer.

Thus, some embodiments of the present invention encompass methods of distributing social stationery that include acts of providing finished articles of a first type of social stationery, in bulk, to a retailer, and providing the retailer with means for producing additional finished articles of the first type of social stationery on-demand. The additional finished articles of the first type of social stationery can be indistinguishable from the bulk finished articles. The means for producing additional finished articles of the first type on-demand may involve; supplies, such as media (paper, envelopes, velum, napkin or card stock, etc.) and/or ink, that enable the additional finished articles to be produced on-demand in a manner that is indistinguishable from the finished articles; software that is adapted for use with an on-demand production facility that allows indistinguishable copies of the finished articles to be produced; an on-demand production facility that may include a computer, software, printers, and finishing facilities, or various combinations of the above.

According to another embodiment of the present invention, a method of distributing social stationery includes acts of providing finished articles of a first type of social stationery, in bulk, to a retailer, and providing the retailer with means for producing additional finished articles of a second type of social stationery on-demand. The additional finished articles of the second type of social stationery coordinate with the finished articles of the first type. The means for producing additional finished articles of the first type on-demand may involve: supplies, such as media (paper, envelopes, velum, napkin or card stock, etc.) and/or ink, that enable the additional finished articles to be produced on-demand to match or otherwise coordinate with the finished articles of the first type; software that is adapted for use with an on-demand production facility to allow coordinated articles to be produced; and an on-demand production facility that may include a computer, software, printers, and finishing facilities, or various combinations of the above.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. For example, as described above, methods and apparatus, according to principles of the invention, are not limited to the above-described examples relating to articles of social stationery. Accordingly, the foregoing description and drawings are by way of example only.

1. A method for merchandizing articles at a retail shop, comprising:
displaying for sale at least one article ready for immediate delivery to a retail customer;
offering for sale a number of the articles that is customer-selectable to permit selection of a number different from a number exactly available from the displayed at least one article;
receiving from a retail customer a request to purchase a number of articles equal to at least two of the articles; and
fabricating at least one article at the retail shop after receiving the request to provide to the retail customer the exact number of requested articles.

2. The method of claim 1, wherein the article comprises a component, and a material printed on the component, and fabricating comprises printing the material onto the component.

3. The method of claim 1, wherein displaying comprises displaying at least one package, wherein each of the at least one package contains at least one of the at least one article.

4. The method of claim 3, wherein each of the at least one package contains at least two of the at least one article.

5. The method of claim 4, wherein the number exactly available is equal to a number available by purchasing packages from the display.

6. The method of claim 4, wherein the requested number is different than a number available by selecting from the displayed at least one package.

7. The method of claim 6, wherein the requested number is fewer than the number of articles contained in any one of the at least one package.

8. The method of claim 1, wherein the articles are selected from the group of articles consisting of: social stationery, rolls of wallpaper; posters, mugs, and formed paper items.

9. The method of claim 1, further comprising restocking a display at least in part by fabricating articles at the retail shop.

10. The method of claim 9, wherein restocking the display comprises restocking in part from a central supplier.

11. The method of claim 9, wherein restocking the display comprises selecting a number of articles for display in response to prior sales data.

12. The method of claim 1, further comprising receiving stock material and ink from a central supplier, wherein fabricating comprises applying the ink to the stock material.

13. The method of claim 12, wherein the stock material is selected from the group of stock materials consisting of: card-stock, wallpaper-stock, poster-stock, plate-stock, and mug-stock.

14. The method of claim 12, wherein the stock material comprises at least one of two-dimensional stock material and three-dimensional stock material.

15. The method of claim 1, further comprising providing a printing system located at the retail shop, wherein fabricating comprises printing.

16. The method of claim 1, further comprising:
offering for sale at least one article of a second type that is associated with the at least one article of the first type; and
fabricating at least one article of the second type at the retail shop to provide to the retail customer a number of articles of the second type associated with the number of requested articles of the first type.
